(19) United States
(12) Patent Application Publication
(10) Pub. No.: US 2008/0205385 A1
(43) Pub. Date: Aug. 28, 2008

(54) DATA FRAME FORMATS TO IMPROVE GROUPCAST EFFICIENCY IN MULTI-HOP WIRELESS NETWORKS

(75) Inventors: Surong Zeng, Schaumburg, IL (US); Keith J. Goldberg, Casselberry, FL (US); Hrishikesh Gossain, Apopka, FL (US); William V. Hasty, Lake Mary, FL (US); Heyun Zheng, DeBary, FL (US); Sebnem Zorlu Ozer, North Wales, PA (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/678,823

(22) Filed: Feb. 26, 2007

(51) Int. Cl. H04L 12/28

(52) U.S. Cl. 370/389

(57) ABSTRACT

Unified groupcast data frame formats are provided for improving the efficiency of groupcast communications in multihop wireless mesh networks, and significantly reducing bandwidth consumption. The unified groupcast data frame formats modify existing BSS data frame formats by inserting a mesh end-to-end sequence number into a field that is normally reserved for a sequence control field. In some implementations, a time-to-live (TTL) value can also be inserted into a QoS control field.

### FIELD OF THE INVENTION

The present invention relates generally to multi-hop communication networks, and in particular to groupcast data frame formats and forwarding groupcast packets within a multi-hop communication network.

### BACKGROUND

An infrastructure-based wireless network typically includes a communication network with fixed and wired gateways. Many infrastructure-based wireless networks employ a mobile unit or host which communicates with a fixed base station that is coupled to a wired network. The mobile unit can move geographically while it is communicating over a wireless link to the base station. When the mobile unit moves out of range of one base station, it may connect or “handover” to a new base station and starts communicating with the wired network through the new base station.

In comparison to infrastructure-based wireless networks, such as cellular networks or satellite networks, ad hoc networks are self-forming networks which can operate in the absence of any fixed infrastructure, and in some cases the ad hoc network is formed entirely of mobile nodes. An ad hoc network typically includes a number of geographically-distributed, potentially mobile units, sometimes referred to as “nodes,” which are wirelessly connected to each other by one or more links (e.g., radio frequency communication channels). The nodes can communicate with each other over a wireless media without the support of an infrastructure-based or wired network. Links or connections between these nodes can change dynamically in an arbitrary manner as existing nodes move within the ad hoc network, as new nodes join or enter the ad hoc network, or as existing nodes leave or exit the ad hoc network.

One characteristic of the nodes is that each node can directly communicate over a short range with nodes which are a single “hop” away. Such nodes are sometimes referred to as “neighbor nodes.” When a node transmits packets to a destination node and the nodes are separated by more than one hop (e.g., the distance between two nodes exceeds the radio transmission range of the nodes, or a physical barrier is present between the nodes), the packets can be relayed via intermediate nodes (“multi-hopping”) until the packets reach the destination node. In such situations, each intermediate node routes the packets (e.g., data and control information) to the next node along the route, until the packets reach their final destination. For relaying packets to the next node, each node maintains routing information collected through communication with neighboring nodes. The routing information can also be periodically broadcast in the network to reflect the current network topology. Alternatively, to reduce the amount of information transmitted for maintaining accurate routing information, the network nodes may exchange routing information only when it is needed. In an approach known as Mesh Scalable Routing (MSR), nodes periodically send HELLO messages (e.g., once per second) that contain routing and metrics information associated with the route to its bound intelligent access point (IAP), and discover certain peer routes on-demand.

A wireless mesh network is a collection of wireless nodes or devices organized in a decentralized manner to provide range extension by allowing nodes to be reached across multiple hops. In a multi-hop network, communication packets sent by a source node can be relayed through one or more intermediary nodes before reaching a destination node. A large network can be realized using intelligent access points (IAP) which provide wireless nodes with access to a wired backhaul.

Wireless ad hoc networks can include both routable (meshed) nodes and non-routable (non-meshed) nodes. Meshed or “routable” nodes are devices which may follow a standard wireless protocol such as Institute of Electrical and Electronics Engineers (IEEE) 802.11s or 802.16j. These devices are responsible for forwarding packets to/from the proxy devices which are associated with them. Non-meshed or “non-routable” nodes are devices following a standard wireless protocol such as IEEE 802.11a, b, e, g or IEEE 802.15 but not participating in any kind of routing. These devices are “proxied” by meshed devices which establish routes for them.

FIG. 1 is a data structure which illustrates a conventional IEEE 802.11 legacy data frame format 100. As shown, the IEEE 802.11 legacy data frame format 100 comprises a MAC data header 105, a packet body field 180 and a frame check sum field (FCS) 190. The MAC data header 105 comprises a frame control field 110, a duration field 120, address fields 130-165, and a sequence control field 160. The body field 180 comprises data or “payload” information. The FCS field 190 contains a cyclic redundancy check to detect errors in the frame which may have occurred during transmission.

Address 4 165 is shown in shading since it is included in only in WDS type data frames. In other words, when Address 4 165 is not included, this version of the conventional IEEE 802.11 legacy data frame format 100 is the conventional IEEE 802.11 legacy Basic Service Set (BSS) data frame format specified in the original IEEE 802.11 standards (i.e., before IEEE 802.11e standard). When Address 4 165 is included, this version of the conventional IEEE 802.11 legacy data frame format 100 is the conventional IEEE 802.11 legacy Wireless Distribution System (WDS) data frame format specified in the original IEEE 802.11 standards (i.e., before IEEE 802.11 e standard).

Notably, the IEEE 802.11 legacy BSS data frame format 100 includes only three address fields 130-150. As such, legacy 802.11 networks using the IEEE 802.11 legacy BSS data frame format 100 are designed to communicate traffic over a single hop (e.g., communicating with its immediate neighbor nodes or APs), and are not designed to communicate in a multi-hop manner since these communications would generally require a fourth address (as in the conventional IEEE 802.11 legacy Wireless Distribution System (WDS) data frame format). Section 9.2.7 of the IEEE 802.11 standards defined in IEEE Std 802.11-1999 (Reaff 2003) specify that broadcast data frames and multicast data frames shall be propagated throughout its entire Extended Service Set (ESS).

The Frame Control field 110 comprises a protocol version sub-field 110A, a type sub-field 110B, a subtype sub-field 110C, a ToDS bit 110D, a FromDS bit 110E, a more fragment bit 110F, a retry bit 110G, a power management bit 110H, a more data bit 101I, a WEP bit 110J and an order bit 110K. In the legacy 802.11 standards, when “To DS” bit is set as zero, an AP should not accept the data frame because it means that the packet is destined to a BSS station. Typically, in the legacy 802.11 standards, WDS traffic should set both “To DS” and “From DS” bits as 1; the traffic from the AP to BSS should set “To DS” bit as 0 and “From DS” bit as 1; and the traffic from BSS stations to the AP should set “To DS” bit as 1 and “From DS” bit as 0.

More recent IEEE 802.11-based networks have been designed to communicate data in a “groupcast” manner across multi-hop throughout the network according to a number of different IEEE 802.11-based standards. Groupcast communication refers to data that is either broadcast or multicast to more than one node or “station.” The purpose of groupcasting a message is to make sure that the groupcast message reaches all nodes of interest in a network which belong to a particular group. The mobility of a multihop ad hoc wireless network causes groupcast communications (i.e. broadcast and multicast communication) to occur more frequently than in other communication networks. Due to the mobile nature of the ad hoc network, groupcasting of messages can cause network problems including redundancy, contention, and collision. Together, these type of issues are referred to by those skilled in the art as a “broadcast storm” problem. In the worst case scenario, a broadcast storm may shut down an entire network.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a data structure which illustrates a conventional IEEE 802.11 legacy data frame format.

FIG. 2 is a block diagram illustrating an example of a communication network.

FIG. 3 is an electronic block diagram of one embodiment of a communication device.

FIG. 4 is a data structure which illustrates a conventional IEEE 802.11e Quality of Service (QoS) data frame format.

FIG. 5 is a data structure which illustrates one possible IEEE 802.11s Wireless Distribution System (WDS) data frame format for use in an IEEE 802.11s wireless mesh network.

FIG. 6 is a block diagram illustrating an example of an IEEE 802.11-based multi-hop communication network.

FIG. 7 is a data structure which illustrates unified groupcast data frame formats in accordance with some embodiments of the present invention.

FIG. 8 is a flowchart illustrating an exemplary method for determining a format of a groupcast packet in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to formatting groupcast application data frames and for groupcast packet forwarding. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions for formatting groupcast application data frames and for groupcast packet forwarding described herein. The non-processor circuits may include, but are not limited to, a radio receiver, a radio transmitter, signal drivers, clock circuits, power source circuits, and user input devices. As such, these functions may be interpreted as steps of a method for formatting groupcast application data frames and for groupcast packet forwarding. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Institute of Electrical and Electronics Engineers (IEEE) 802.11 Standards

As used herein, “IEEE 802.11” refers to a set of IEEE Wireless LAN (WLAN) standards that govern wireless networking transmission methods. IEEE 802.11 standards have been and are currently being developed by working group 11 of the IEEE LAN/MAN Standards Committee (IEEE 802). Any of the IEEE standards or specifications referred to herein may be obtained at http://standards.ieee.org/getieee802/index.html or by contacting the IEEE at IEEE, 445 Hoes Lane, PO Box 1331, Piscataway, N.J. 08855-1331, USA.

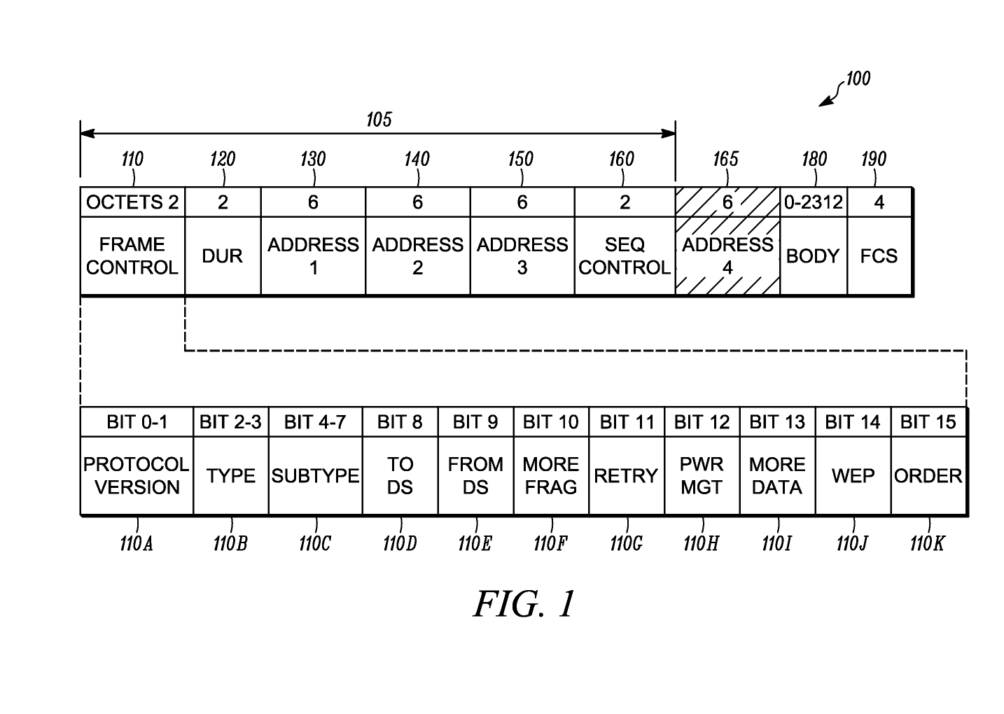

As used herein, the “IEEE 802.11 legacy” standards refer to the original IEEE 802.11 standard and amendments (e.g., the IEEE 802.11a, IEEE 802.11b, and IEEE 802.11g revisions) to the original IEEE 802.11 standards which were ratified before IEEE 802.11e amendments to the original IEEE 802.11 standards. The IEEE legacy standards use the data frame format shown in FIG. 1 for packet forwarding. There is no data frame format difference between the original IEEE 802.11 standard, and the IEEE 802.11a, b, and g revisions to the original IEEE 802.11 standard. Since the development of the IEEE 802.11 legacy standards, several other amendments have been made (e.g., IEEE 802.11e, IEEE 802.11s). As used herein, the term “legacy station (LSTA)” refers to a non-routable station or node which complies with the IEEE 802.11 legacy standards prior to the IEEE 802.11e amendment and uses the MAC frame format as shown in FIG. 1 for data frame forwarding.

In an IEEE 802.11 wireless LAN (WLAN), the coverage of one Access Point (AP) is called a Basic Service Set (BSS). An AP acts as a master to control the stations (STAs) within that BSS. Each BSS is identified by a basic service set identifier (BSSID). In addition to BSSID, another SSID is used to identify an Extended Service Set (ESS), which uniquely identifies a group of wireless network devices used in a given “Service Set.” An AP broadcasts its SSID (“network name”) via packets that are called beacons. In infrastructure mode, groups of BSSs can be connected together with the use of a backbone network and form a network called an extended service set (ESS). Extended Service Set (ESS) refers to a set of one or more interconnected BSSs and integrated local area networks (LANs) that appear as a single network to the logical link control layer at any station associated with one of those BSSs.

As used herein, “IEEE 802.11e” refers to an amendment to the original IEEE standards that enhances the original IEEE 802.11 Media Access Control (MAC) layer and defines a set of Quality of Service (QoS) enhancements. The IEEE 802.11e standard is important for delay-sensitive applications, such as Voice over IP (VoIP) and streaming multimedia. As used herein, the term “IEEE 802.11e QoS data frame format” refers to a data frame format used in networks proposed in a set of specifications which make up the IEEE 802.11e standard. As used herein, a QoS station (QSTA) refers to a non-routable station or node which complies with the IEEE 802.11e standard and which supports QoS functionality defined in the IEEE 802.11e standard. As used herein, the term “Quality of Service Access Point (QAP)” refers to an access point (AP) which complies with the IEEE 802.11e standard and supports QoS functionality defined in the IEEE 802.11e standard. QAPs and QSTAs also comply with the original or “legacy” versions of the IEEE 802.11 standards.

As used herein, “IEEE 802.11s” refers to a set of IEEE draft standards currently being developed (i.e., unapproved at present) by IEEE under the title 802.11s. IEEE 802.11 s defines an architecture and protocol for Extended Service Set (ESS) Mesh Networking. IEEE 802.11s specifies an extension of the original IEEE 802.11 Medium Access Control (MAC) layer to solve the interoperability problem by defining an architecture and protocol that support both broadcast/multicast and unicast delivery using “radio-aware metrics over self-configuring multi-hop topologies.” The protocol will provide auto-configuring paths between APs over configuring multi-hop topologies in a Wireless Distribution System (WDS) to support both broadcast/multicast and unicast traffic in an ESS Mesh. As used herein, the term “IEEE 802.11s WDS data frame format” refers to a data frame format used in a Wireless Distribution System (WDS) system proposed in a set of specifications which make up the IEEE 802.11 s standard.

As used herein, the term “Wireless Distribution System (WDS)” refers to a system that enables the interconnection of access points wirelessly. WDS allows a wireless network to be expanded using multiple access points without the need for a wired backbone to link them as is traditionally required. Non-routable devices such as LSTA or QSTA can join the network through their associated access point. These access points are routable devices which provide proxying functionality for those non-routable devices, and are able to route the traffic generated by a non-routable device associated with it to the correct remote destination which can be a routable or non-routable device.

As used herein, the term “meshed access point” refers to any type of access point that is designed to perform forwarding and/or relaying and/or repeating and/or routing for other devices over the WDS. In one embodiment, the term “meshed access point (MAP)” can refer to a routable AP which has mesh routing capability, such as those complying with the IEEE 802.11s standard, and that is able to provide proxy functionality to non-routable devices associated with it. As used herein, the term “meshed point (MP)” refers to a routable AP/station which has mesh routing capability, such as complying with the IEEE 802.11s standard, but that is not able to provide association service and proxy functionality to other non-routable devices. A meshed point (MP) can only communicate with a MAP, and can not directly communicate with other stations.

As used herein, the term “packet” refers to is a formatted block of information carried by a network. As used herein, the term “frame” refers to a packet of fixed or variable length which has been encoded. The terms “frame” and “packet” are used interchangeably throughout this description.

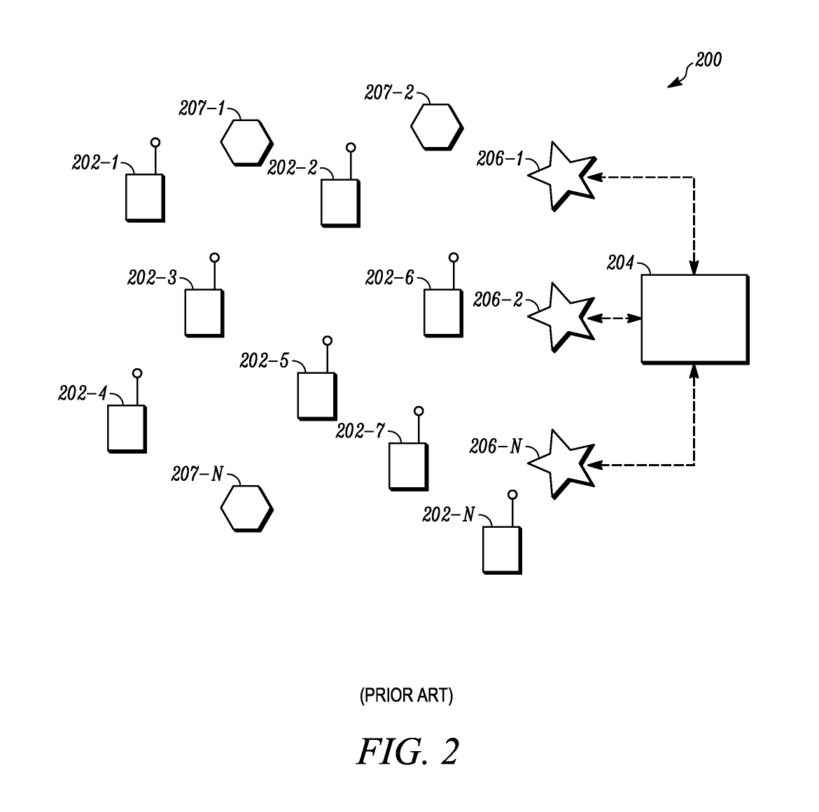

FIG. 2 is a block diagram illustrating an example of a communication network 200. The communication network 200 can be a mesh enabled architecture (MEA) network, an IEEE 802.11 network (i.e. 802.11a, 802.11b, 802.11g, 802.11e or 802.11s), or any other packetized mesh communication network.

As illustrated in FIG. 2, the communication network 200 includes a plurality of mobile nodes 202-1 through 202-n (referred to generally as nodes 202 or mobile nodes 202 or mobile communication devices 202), and can, but is not required to, include a fixed network 204 having a plurality of intelligent access points (IAP) 206-1, 206-2, . . . 206-n (referred to generally as nodes 206 or access points 206), for providing nodes 202 with access to the fixed network 204. The fixed network 204 can include, for example, a core local access network (LAN), and a plurality of servers and gateway routers to provide network nodes with access to other networks, such as other ad-hoc networks, a public switched telephone network (PSTN) and the Internet. The communication network 200 further can include a plurality of fixed or mobile routers 207-1 through 207-n (referred to generally as nodes 207 or communication devices 207) for routing data packets between other nodes 202, 206 or 207. It is noted that for purposes of this discussion, the nodes discussed above can be collectively referred to as “nodes 202, 206 and 207”, or simply “nodes” or alternatively as “communication devices.”

As can be appreciated by one skilled in the art, the nodes 202, 206 and 207 are capable of communicating with each other directly or indirectly. When communicating indirectly, one or more other nodes 202, 206 or 207, can operate as a router or routers for forwarding or relaying packets being sent between nodes.

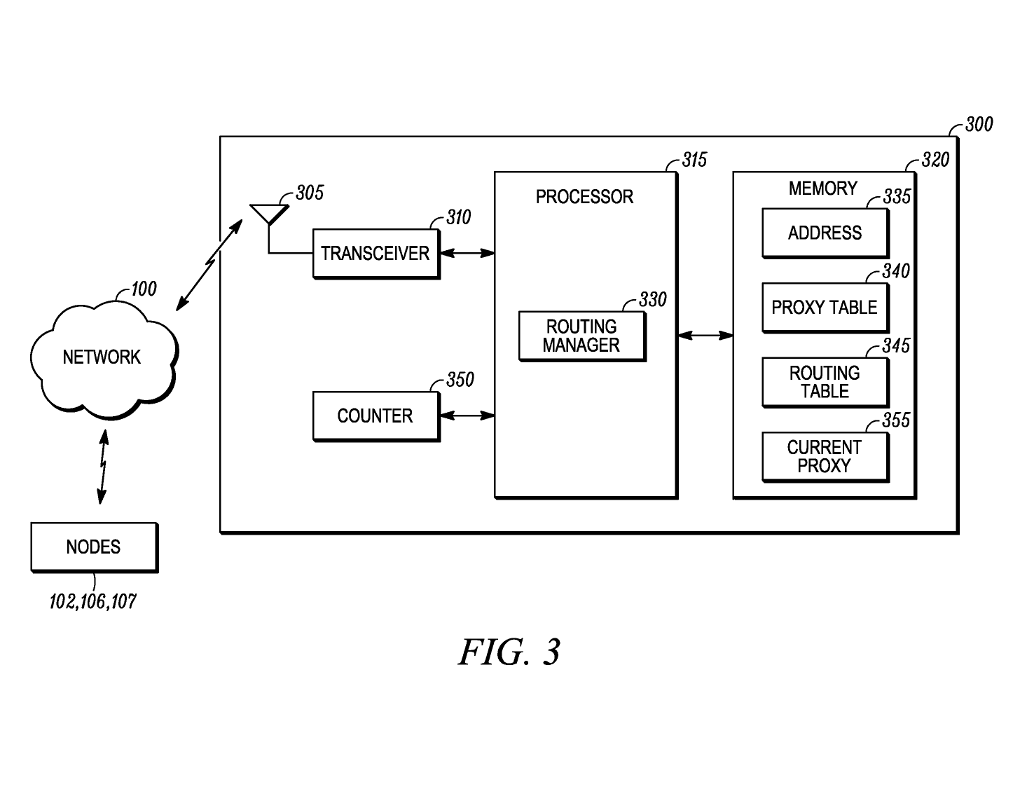

FIG. 3 is an electronic block diagram of one embodiment of a communication device 300. The communication device 300, for example, can exemplify one or more of the nodes 202, 206, and 207 of FIG. 2. In accordance with some embodiments of the present invention, the communication device 300 can be a mesh routable device or alternatively can be a non-meshed non-routable device. As illustrated, the communication device 300 includes an antenna 305, a transceiver (or modem) 310, a processor 315, and a memory 320.

The antenna 305 intercepts transmitted signals from one or more nodes 202, 206, 207 within the communication network 200 and transmits signals to the one or more nodes 202, 206, 207 within the communication network 200. The antenna 305 is coupled to the transceiver 310, which employs conventional demodulation techniques for receiving and transmitting communication signals, such as packetized signals, to and from the communication device 300 under the control of the processor 315. The packetized data signals can include, for example, voice, data or multimedia information, and packetized control signals, including node update information. When the transceiver 310 receives a command from the processor 315, the transceiver 310 sends a signal via the antenna 305 to one or more devices within the communication network 200. In an alternative embodiment (not shown), the communication device 300 includes a receive antenna and a receiver for receiving signals from the communication network 200 and a transmit antenna and a transmitter for transmitting signals to the communication network 200. It will be appreciated by one of ordinary skill in the art that other similar electronic block diagrams of the same or alternate type can be utilized for the communication device 300.

When the communication device 300 is a routable device, the processor 315 may include a routing manager 330 for managing packet forwarding within the communication network 100. Although the routing manager 330 can be contained within the processor 315 as illustrated, in alternative implementations, the routing manager 330 can be an individual unit operatively coupled to the processor 315 (not shown). It will be appreciated by those of ordinary skill in the art that the routing manager 330 can be hard coded or programmed into the node 300 during manufacturing, can be programmed over-the-air upon customer subscription, or can be a downloadable application. It will be appreciated that other programming methods can be utilized for programming the routing manager 330 into the communication device 300. It will be further appreciated by one of ordinary skill in the art that routing manager 330 can be hardware circuitry within the communication device 300.

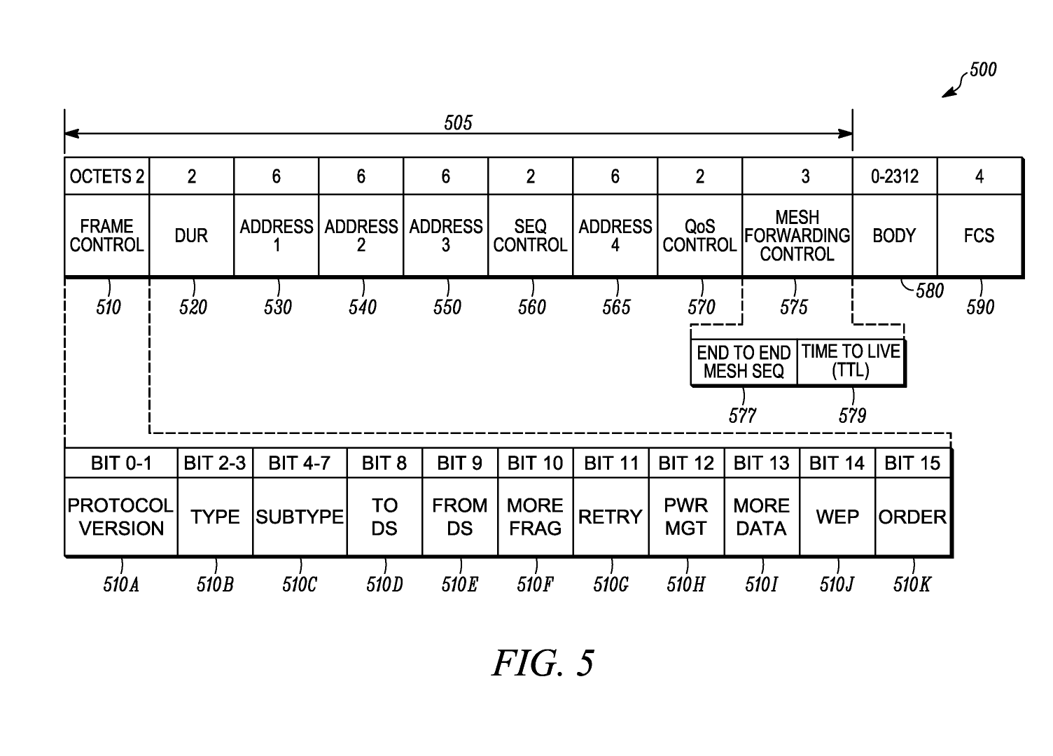

The communication device 300 further includes a counter 350 coupled to the processor 315. In operation, the processor 315 generates a sequence number for each data packet using sequence numbers assigned from the counter 350, starting at zero (0) and incrementing by one (1) for each data packet. For example, when the node is a non-routable device, the processor 315 can generate a one-hop sequence number to be associated with each generated data packet. Further, in accordance with the present invention, when a node that is a routable device (e.g., proxy node) receives a data packet from a non-routable device with the one-hop sequence number, the routing manager 330 of the routable device utilizes the one-hop sequence number (e.g., included in the packet data frame field 560 of FIG. 5) to be the end-to-end groupcast sequence number (e.g., included in the data frame field 575 of FIG. 5) for forwarding the groupcast traffic originated from the non-routable device. Alternatively, when the communication device 300 is a routable device, the routing manager 330 can generate an end-to-end sequence number using the counter 350 to identify a groupcast packet originated by the routable device.

To perform the necessary functions of the communication device 300, the processor 315 and/or the routing manager 330 are each coupled to the memory 320, which preferably includes a random access memory (RAM), a read-only memory (ROM), an electrically erasable programmable read-only memory (EEPROM), and flash memory. The memory 320 includes storage locations for the storage of one or more identifying address 335 such as the MAC address of the communication device 300. The memory 320 further includes storage locations for the storage of a current proxy node 355 and associated information. When the communication device 300 is a routable device, the memory 320, in accordance with the present invention, further includes storage locations for the storage of a proxy table 340, and a routing table 345. The routing table 345 and the proxy table 340 are maintained to identify a non-routable communication device 300 and its corresponding AP (routable device) 305. These tables can also be combined to create a single forwarding table. It will be appreciated by those of ordinary skill in the art that the memory 320 can be integrated within the communication device 300, or alternatively, can be at least partially contained within an external memory such as a memory storage device.

The proxy table 340 typically contains an entry for each device that is associated with the communication device 300 (i.e. each device that is being proxied by the communication device 300). A communication device 300 can also have nodes or devices associated with it through a wired Ethernet port or through some other wired/wireless protocol like IEEE 802.15, Token Ring, or the like as can be appreciated by one skilled in the art. A proxy table 340 of a node may also contain entries for non-meshed devices that are associated with other nodes but use that node as an intermediate node to communicate with other devices in the network. Each entry in the proxy table 340 may include one or more of the following pieces of information (not shown):
Device media access control (MAC) Address (if MAC addressing scheme is used)
Device IP address (if IP addressing scheme is used)
Device ID (if an addressing scheme other than IP or MAC is used)
Static or Dynamic Entry (i.e. whether the entry is static or dynamic)
Associated AP address (the address can be MAC address, Internet Protocol (IP) address or other device identification (ID) depending on which addressing scheme is used—this entry is used if node is maintaining association information for non-meshed nodes associated with other AP. This is useful when a four (4) addressing scheme is used in the network)
Expiration time of the entry

As described herein, non-meshed devices are proxied by meshed devices. Each meshed device maintains the proxy table 340 and the routing table 345. The routing table 345 maintains routes to other meshed devices. The communication device 300 constantly updates its routing table 345 so as to maintain a consistent and up-to-date view of the network. When the network topology changes the nodes propagate update messages throughout the network in order to maintain consistent and up-to-date routing information about the whole network. These routing protocols vary in the method by which the topology change information is distributed across the network and the number of necessary routing-related tables.

The routing manager 330 of the communication device 300 consults both the proxy table 340 and the routing table 345 to determine how to forward a data packet it has either generated or has received.

Prior to describing an exemplary implementation of the invention, a detailed discussion of various data frame formats used in IEEE 802.11 wireless networks will be provided. In current IEEE 802.11 wireless networks, a meshed access point (MAP) can use at least two different types of groupcast data frame formats for communicating groupcast information according to current 802.11 standards.

IEEE 802.11e Quality of Service Data Frame Format

One existing groupcast data frame format is sometimes referred to as a groupcast Basic Service Set (BSS) data packet format defined in the IEEE 802.11e standard (referred to herein as “an IEEE 802.11e QoS BSS (QBSS) data frame format”). In addition to all of the information required by the legacy IEEE 802.11 data frame format described above with reference to FIG. 1, the IEEE 802.11e QoS data frame format also includes an additional QoS control field which is used to carry additional QoS information.

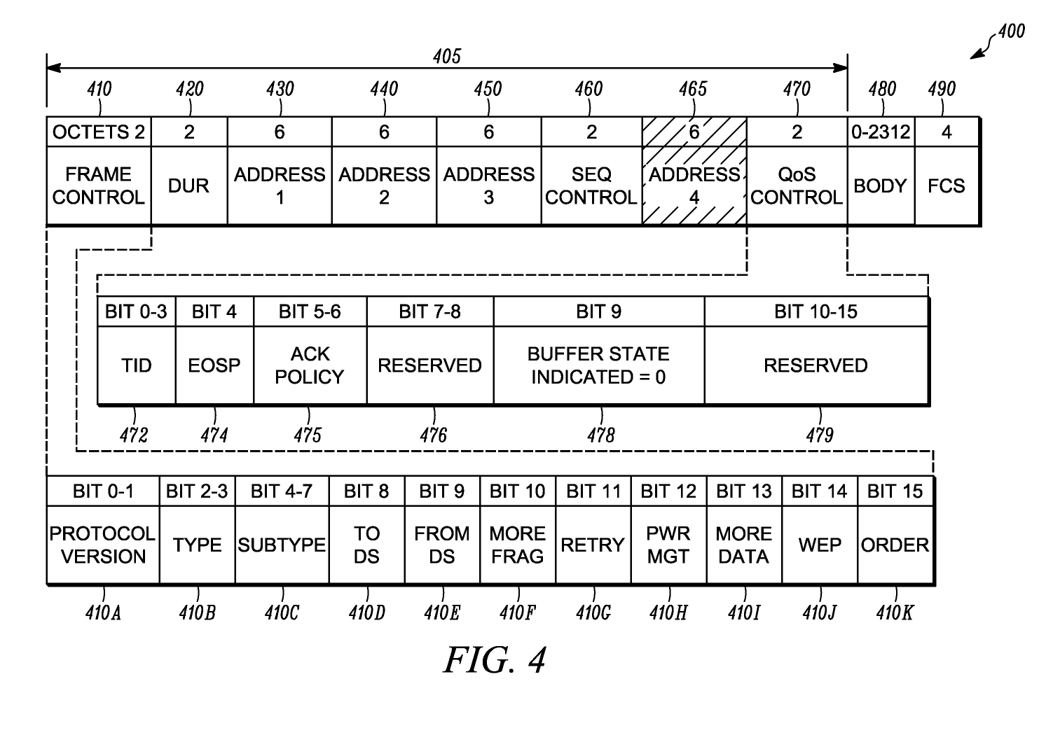

FIG. 4 is a data structure which illustrates a conventional IEEE 802.11e QoS data frame format 400 for use in an IEEE 802.11e network. The IEEE 802.11e QoS data frame format 400 is similar to the IEEE 802.11 legacy data frame format 100 discussed above, and comprises a MAC data header 405, a packet body field 480 and a frame check sum field (FCS) 490. The MAC header 405 comprises a frame control field 410, a duration field 420, address fields 430-465, a sequence control field 460, and a QoS control field 470. The body field 480 comprises data or “payload” information. The body field 480 moves the higher-layer payload from station to station. The FCS field 490 contains a cyclic redundancy check (CRC) which allows stations to check the integrity of the received frames and to detect errors in the frame which may have occurred during transmission. The FCS field 490 is calculated over the MAC header 405 and the packet body field 480.

The frame control field 410 comprises a protocol version sub-field 410A, a type sub-field 410B, a subtype sub-field 410C, a ToDS bit 410D, a FromDS bit 410E, a more fragment bit 410F, a retry bit 410G, a power management bit 410H, a more data bit 410I, a WEP bit 410J and an order bit 410K.

The duration field 420 contains a duration time value that is proportional to the length of the frame in bits. The structure of the frame control field 410 and the duration field 420 are well-known by those skilled in the art and will not be described in further detail herein.

When the ToDS bit is set to 0 and from DS bit is set to 1, as in the case of frame forwarding from an AP to its associated STAs or in BSS, the address fields 430-450 comprise a destination address field (Address 1) 430 that identifies the final recipient of the data frame (e.g., the station that will hand the frame to the higher protocol layers for processing), a BSSID/transmitter address field (Address 2) 440 that identifies the MAC address used by the wireless interface (in the AP) that transmitted the frame onto the wireless medium, and a source address field (Address 3) 450 that identifies the source of the transmission. The address fields 430-450 each comprise a 48-bit IEEE MAC identifier. If the first bit sent to the physical medium is a 0, the address represents a single station (unicast). When the first bit is a 1, the address represents a group of physical stations and is called a multicast (or group) address. If all bits are 1s, then the frame is a broadcast and is delivered to all stations connected to the wireless medium. For the group traffic, destination address field (Address 1) 430 carries the groupcast address (including broadcast and multicast address), transmitter address field (Address 2) 440 carries the transmitting AP's MAC address, and source address field (Address 3) 450 carries the original source node address which can be an 802.11 station or an AP. Similar to FIG. 1, Address 4 465 is shown in shading since it is included only in WDS type data frames. In other words, when Address 4 465 is not included, this version of the conventional IEEE 802.11e QoS data frame format 400 is the conventional IEEE 802.11e QoS Basic Service Set (BSS) data frame format specified in the IEEE 802.11e standards. When Address 4 465 is included, this version of the conventional IEEE 802.11e data frame format 400 is the conventional IEEE 802.11e QoS Wireless Distribution System (WDS) data frame format specified in the IEEE 802.11e standards.

The sequence control field 460 value is set by transmitter to permit the receiver to correctly process received frames by placing received frames in the order in which they were sent and to eliminate duplicate received frames. The sequence control field 460 value comprises a 4-bit fragment number field and a 12-bit sequence number field. The sequence control field 460 value can be used for both defragmentation and discarding duplicate frames.

The IEEE 802.11e QoS data frame format 400 also requires the additional QoS control field 470 that is not included in the conventional or “legacy” 802.11 BSS data frame format 100. The quality of service (QoS) control field 470 comprises a control field which is used to provide QoS services and provide service differentiation to different classes of traffic based on their Traffic Identifier (TID). The quality of service (QoS) control field 470 identifies the traffic class (TC) or traffic stream (TS) to which the frame belongs and various other QoS-related information about the frame that varies by frame type and subtype. As shown in FIG. 4, the QoS control field 470 comprises a number of sub-fields 472-479 (as shown in the bottom portion of FIG. 4) including a Traffic Identification (TID) sub-field 472, an End Of Service Period (ESOP) sub-field 474, an acknowledgement (ACK) policy sub-field 475 that specifies a type of acknowledgement policy being used (these are defined in the IEEE 802.11e standards), reserved sub-fields 476, 479 and a buffer state indicated sub-field 478. The TID sub-field 472 include 16 bits; bits 0-7 are used to identify a traffic class which is mapped to a particular Access Category (AC) queue. Each AC queue has its own priority to access the channel. Bits 8-15 are used for flow reservation purpose. The details regarding each sub-field in the QoS control field 470 are described in the IEEE 802.11e standard and will not be described in further detail herein.

IEEE 802.11s Wireless Distribution System (WDS)

The IEEE 802.11s draft standard defines another data frame format that is sometimes referred to as a Wireless Distribution System (WDS) mesh data packet format (referred to herein as “an IEEE 802.11s WDS mesh data frame format”). In all implementations, stations operating in accordance with the IEEE 802.11s standard also operate in compliance with IEEE 802.11e standards. The IEEE 802.11s WDS mesh data frame format is built on top of the IEEE 802.11e QoS WDS data frame format.

FIG. 5 is a data structure which illustrates one embodiment of an IEEE 802.11s WDS mesh data frame format 500 for use in an IEEE 802.11s wireless mesh network. This variation of the IEEE 802.11s WDS mesh data frame format 500 is described in U.S. patent application Ser. No. 11/383,130, filed May 12, 2006, and entitled “System and Method for Groupcast Packet Forwarding in a Wireless Network,” which is incorporated by reference herein in its entirety. As illustrated in FIG. 5, the IEEE 802.11s WDS mesh data frame format 500 includes a MAC data header 505, a packet body field 580 and a frame check sum field (FCS) 590. The body field 580 and the FCS field 590 are similar to the body field 480 and the FCS field 490 described above with reference to FIG. 4. As will be described below, the IEEE 802.11 s standard requires that “multihop” capability be supported. To provide multihop capability the IEEE 802.11s WDS mesh data frame format 500 utilizes an additional address (e.g., at least four (4) addresses in total and up to six (6) address in total if non-meshed devices (STAs) are to be identified). The IEEE 802.1 s WDS mesh data frame format 500 also includes a sequence number called a mesh end-to-end sequence number in the Mesh Forwarding Control field which can be used to control duplicate packets over a multi-hop path.

The MAC data header 505 comprises a frame control field 510, a duration field 520, a receiver address field 530, a transmitter address field 540, a destination address field 550, a sequence control field 560, a source address field 565, quality of service (QoS) control field 570 and a mesh forwarding control field 575.

The frame control field 510 comprises a protocol version sub-field 510A, a type sub-field 510B, a subtype sub-field 510C, a ToDS bit 510D, a FromDS bit 510E, a more fragment bit 510F, a retry bit 510G, a power management bit 510H, a more data bit 510I, a WEP bit 510J and an order bit 510K. The duration field 520 contains a duration time value that is proportional to the length of the frame in bits. The structure of the frame control field 510 and the duration field 520 are well-known by those skilled in the art and will not be described in further detail herein.

The MAC data header 505 comprises four address fields 530, 540, 550, 565 which can be utilized for identifying MAC addresses associated with the routing of various communication packets. When four address fields 530-550, 565 are used packets can be forwarded in a multihop scenario. Those of ordinary skill in the art will appreciate that two of these address fields are used to identify the immediate next hop and the node presently forwarding the packet. Other two of these address fields are used to identify the final destination and original source of the packet.

The address fields 530-550, 565 each comprise a 48-bit IEEE MAC identifier. If the first bit sent to the physical medium is a 0, the address represents a single station (unicast). When the first bit is a 1, the address represents a group of physical stations and is called a multicast (or group) address. If all bits are 1s, then the frame is a broadcast and is delivered to all stations connected to the wireless medium.

The receiver address field (Address 1) 530 indicates which station should process the frame. If the receiver is a station, then the receiver address field (Address 1) 530 is the destination address. If the receiver of the frames is destined to a node on an Ethernet connected to an access point, then the receiver address field (Address 1) 530 is the wireless interface in the access point, and the destination address may be a router attached to the Ethernet. The receiver address field (Address 1) 530 may be either the unicast address of the node (or “meshed point”) that is the immediate intended receiver of the frame or the multicast or broadcast address of the nodes (or “meshed points”) that are the immediate intended receivers of the frame. A node (or “meshed point”) uses the contents of the receiver address field 530 to perform address matching for receive decisions. For groupcast traffic, the receiver address field (Address 1) 530 carries the groupcast address (including broadcast and multicast address).

The transmitter address field (Address 3) 540 is the address of the node (or “meshed point”) that is transmitting the frame (e.g., identifies the MAC address used by the wireless interface in the AP or in the context of wireless bridging identifies the wireless interface that transmitted the frame onto the wireless medium). A node (or “meshed point”) uses the contents of the transmitter address field (Address 3) 540 to direct an acknowledgment if acknowledgment is necessary. When a meshed access point generates by itself or forwards group traffic for non-routable station associated with it, the transmitter address field (Address 2) 540 carries the MAC address of the transmitting meshed access point (MAP).

The destination address field (Address 3) 550 is the destination address of the data in the frame body field 580, and identifies the final recipient of the data frame (e.g., the station that will hand the frame to the higher protocol layers for processing). For groupcast traffic, the destination address field (Address 3) 550 of the WDS mesh data frame 500 is same as the receiver address field (Address 1) 530 carrying the groupcast address and is therefore duplicate information.

The source address field (Address 4) 565 identifies the original source node address of the transmission which can be an 802.11 station or an AP. The source address field 565 is the address of the node (or “meshed point”) that initiated the data in the frame body field 580.

The sequence control field 560 value is set by a transmitting meshed point to permit a receiving meshed point to correctly process received unicast frames by placing received frames in the order in which they were sent and to eliminate duplicate received unicast frames over one-hop wireless link.

The 802.11s MAC layer is built on the top of the IEEE 802.11e MAC, and MAPs and MPs which comply with the 802.11s MAC layer should also comply with the 802.11e MAC layer. Therefore, when QoS capability is provided, the IEEE 802.11s WDS mesh data frame format 500 includes information which would be part of the IEEE 802.11e data frame format 400 such as the QoS control field 470. As such, the quality of service (QoS) control field 570 is similar to the QoS control field 470 described above with reference to FIG. 4.

The mesh forwarding control field 575 which comprises a mesh end-to-end sequence number value 577 and a time-to-live (TTL) value 579. In contrast to the QBSS data frame format 400, the IEEE 802.11s WDS data frame format 500 includes a mesh end-to-end sequence number value 577 to detect the network wide duplicate groupcast packets and the TTL value 579 to control the groupcast packet propagation range.

The mesh end-to-end sequence number field 577 comprises an end-to-end sequence number for the network wide groupcast packet duplicate detection which allows the destination node to properly order data units received from a source node, detect duplicate groupcast packets, and avoid communication of duplicate groupcast packets. The mesh end-to-end sequence number field 577 is paired with the source address carried in the address 4 field 565 to form a tuple <source address field (Address 4) 565, mesh end-to-end sequence number field 577> which can be used to detect duplicate groupcast packets as defined in 802.11s standard draft and further described in U.S. patent application Ser. No. 11/383,130, filed May 12, 2006, and entitled “System and Method for Groupcast Packet Forwarding in a Wireless Network,” which is incorporated by reference herein in its entirety.

The time-to-live (TTL) field 579 mitigates the possibility of certain routing errors in a mesh network, and is used to control the groupcast traffic propagation range (e.g., the propagation range of the multi-hop groupcast packet) by specifying the number of hops the packet is allowed to pass before it dies. The source MAP/MP sets the TTL field with a non-zero value. Each receiving node reduces or decrements the TTL value by 1 for each non-duplicate groupcast packet before transmission of the frame, and if the adjusted TTL value is larger than zero, the node will re-broadcast this groupcast packet. A node discards a frame when the TTL reaches zero.

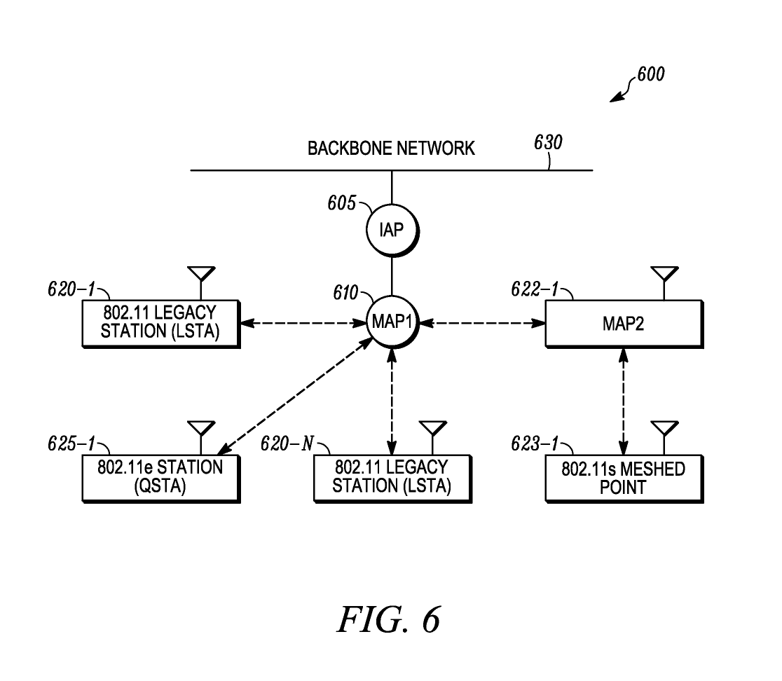

FIG. 6 is a block diagram illustrating an example of an IEEE 802.11-based communication network 600.

The network 600 comprises an Infrastructure Access Point (IAP) 605 coupled to a backbone network 630, a meshed access point (MAP) 610, and a plurality of nodes or stations 620-625 attached (either directly or indirectly) to the MAP1 610. MAP1 610 can be a meshed device which complies with the IEEE 802.11s standard. MAP1 610 communicates with the backbone network 630 via IAP 605. The IAP 605 is a portal into the backbone network 630. The backbone network 630 can be a layer 2 distribution system such as the Ethernet. The nodes or stations 620-625 are attached to MAP1 610 via wireless links which are represented in FIG. 6 as double-headed dashed-line arrows. Although the plurality of nodes or stations 620-625 are shown as comprising two IEEE 802.11 legacy stations (LSTAs) 620-1, 620-N, an IEEE 802.11e Quality of Service Station (QSTA) 625-1, an IEEE 802.11s meshed point 623-1 and an IEEE 802.11 s MAP2 622-1, it will be appreciated by those skilled in the art that, at any given time, the number of nodes or stations attached to the MAP1 610 can vary. It will be appreciated by those skilled in the art that, at any given time, the types of nodes or stations attached to the MAP1 610 can also vary. For example, in some scenarios, the nodes or stations attached to the MAP1 610 may include only LSTAs, only QSTAs, only meshed points (MPs) or only MAPs, while in other scenarios the nodes or stations attached to the MAP 610 may include any number of LSTAs, QSTAs, meshed points and/or MAPs.

Before MAP1 610 can transmit a groupcast packet the MAP1 610 should determine what types of devices or stations are attached to it so that MAP1 610 can determine how many copies of the groupcast packet it needs to transmit and which data frame formats it should use for those groupcast packets.

For example, in some scenarios, the attached nodes or stations may consist of only LSTAs, and there are no existing meshed WDS (i.e., there are no meshed points (MPs) and Meshed Access Points (MAPs) in its neighborhood). In such scenarios, according to 802.11 standards, MAP1 610 needs to transmit a groupcast packet which has a legacy IEEE 802.11 BSS data frame format 100.

In other scenarios, the attached nodes or stations may consist of only QSTAs, and there are no existing meshed WDS (i.e., there is no meshed points (MPs) and MAPs (MAPs) in its neighborhood). In such scenarios, MAP1 610 needs to transmit a groupcast packet which has an IEEE 802.11e QoS BSS (QBSS) data frame format 400. In other words, if the recipient stations are all IEEE 802.11e QoS stations or QSTAs, then the MAP1 610 can send packets having the IEEE 802.11e QoS BSS (QBSS) data frame format.

In still other scenarios, the attached nodes or stations may consist of only meshed points (MPs) and meshed APs (MAPs). In such scenarios, MAP1 610 can transmit a groupcast packet which has an IEEE 802.11s WDS mesh data frame format 500 which includes additional information, such as a fourth address 565, a mesh end-to-end sequence number field 577, and a time-to-live (TTL) field 579, and a QoS control field 570.

In many practical scenarios, however, the nodes or stations attached to the MAP1 610 will comprise a mixture of LSTAs, QSTAs, QAPs, MAPs and/or other meshed points. From the discussion above regarding the different data frame formats, it is evident that in modem IEEE 802.11-based networks some incompatibilities exist between the different data frame formats 100, 400, 500. This presents a problem for MAP1 610 since MAP1 610 must then transmit multiple copies of the same groupcast packet using the different data frame formats 100, 400, 500 required by each of the attached nodes or stations.

For example, when the recipient stations include a mixture of QSTAs and LSTAs, LSTAs are unable to process packets having the IEEE 802.11e QoS BSS (QBSS) data frame format since LSTAs are unable to properly decode the additional QoS control field 670. To further complicate the situation, LSTAs do not have meshing capability, and can not recognize any extra meshing related packet fields used in the IEEE 802.11s WDS data frame format. For LSTAs to accept a groupcast data frame, the groupcast data frame must follow the legacy 802.11 BSS data frame format which has a limited number of BSS data frame fields. Therefore, the MAP1 610 can send a copy of the groupcast packet having the legacy IEEE 802.11 BSS data frame format so that both LSTAs and QSTAs can recognize the groupcast data frame properly.

Similarly, when the recipient stations include a mixture of IEEE 802.11s MAPs and MPs and LSTAs, LSTAs are unable to process packets having the IEEE 802.11s WDS mesh data frame format 500 since LSTAs do not have meshing capability and are unable to properly decode the additional meshing related packet fields used in the IEEE 802.1 is WDS mesh data frame format, such as a fourth address 565, a mesh end-to-end sequence number field 577, and a time-to-live (TTL) field 579. For LSTAs to accept a groupcast data frame, the groupcast data frame must follow the legacy 802.11 BSS data frame format which has a limited number of BSS data frame fields. According to the existing IEEE 802.11 standards, the MAP1 610 has to send the LSTAs one copy of the groupcast packet having the legacy IEEE 802.11 BSS data frame format, and then send the IEEE 802.11s meshed access points (MAPs) and meshed points (MPs) another copy of the groupcast packet having the IEEE 802.11s WDS mesh data frame format 500.

Consider another example in which MAP1 610 has at least one QSTA and at least one meshed device attached to MAP1 610. When MAP1 610 decides to communicate groupcast traffic to QSTAs and MAPs in its Extended Service Set (ESS) (e.g., connected by the WDS), MAP1 610 must communicate one packet having an IEEE 802.11e QoS BSS (QBSS) data frame format, and another packet having an IEEE 802.11s WDS mesh data frame format. Consequently, the same groupcast data must be sent twice—once in an IEEE 802.11e QoS BSS (QBSS) data frame format so that the QSTAs can accept it, and again in an IEEE 802.11s WDS data frame format so that the MAPs in the WDS can accept it.

Unfortunately, communicating multiple copies of groupcast packets which comply with different data frame formats can be wasteful since it consumes large amounts of network bandwidth. To avoid wasting capacity, it would be desirable to avoid sending the same groupcast information twice with different data frame formats. It would be desirable to provide a single data frame format which can be interpreted by LSTAs, QSTAs, and/or meshed devices and MAPs. For example, it would be desirable to provide a single data frame format which contains all information needed for the IEEE 802.11s WDS mesh data frame format 500 and can be interpreted by an IEEE 802.11 legacy station.

As noted above, for groupcast communications, the destination address field (Address 3) 550 of the IEEE 802.11s WDS data frame format 500 is same as the receiver address field (Address 1) 530 carrying the groupcast address and is therefore duplicate information. As such, it was observed that the IEEE 802.11 legacy Basic Service Set (BSS) data frame format 100 or the IEEE 802.11e QBSS data frame format 400 can accommodate enough address information for network wide communication of groupcast packets because receiver address and destination address are the same (i.e., both are the groupcast address) and only one is needed. However, neither the IEEE 802.11 legacy Basic Service Set (BSS) data frame format 100 nor the IEEE 802.11e QBSS data frame format 400 carry the important mesh end-to-end sequence number 577 that is used to detect the network-wise duplicate groupcast packets or the TTL value 579 that is used to control the groupcast packet propagation range in a multi-hop mesh network by specifying the number of hops the packet is allowed to pass before it dies.

Unified Groupcast Data Frame Formats

According to embodiments of the present invention, a unified groupcast data frame format is provided for improving the efficiency of groupcast communications in multihop wireless mesh networks, and significantly reducing bandwidth consumption. Techniques are provided for unifying different data frame formats into modified BSS data frame formats.

In one embodiment, a first unified groupcast data frame format may comprise all of the information required by the legacy IEEE 802.11 BSS data frame format, and the IEEE 802.11s WDS mesh groupcast data frame format. The first unified groupcast data frame format allows the information required by the IEEE 802.11s WDS mesh groupcast data frame format to be provided within a modified legacy IEEE 802.11 BSS data frame format. In other words, the first unified groupcast data frame format combines information needed in both the legacy IEEE 802.11 BSS data frame format and the IEEE 802.11s WDS data frame format so that only one copy of a groupcast data frame needs to be sent to a shared medium so that stations in the BSS and meshed access points (MAPs) and meshed points (MPs) in the WDS can both receive the same packet and interpret it properly. The first unified groupcast data frame format can also be modified such that the MAPs and MPs in the WDS are required to accept all the groupcast data packets even the “To DS” bit is set as zero. The first unified groupcast data frame format is useful, for example, in the context of groupcast communications which occur in some IEEE 802.11s compliant networks where at least one LSTA presents in the BSS of the transmitting MAP.

Moreover, the first unified groupcast data frame format is also compatible with the legacy IEEE 802.11 BSS data frame format used by existing “legacy” 802.11 stations (LSTAs) which follow the original 802.11 standards and which do not have meshing capability (and therefore can not recognize any extra meshing related packet field(s)). To allow 802.11 LSTAs to accept the first unified groupcast data frame format, the first unified groupcast data frame format follows or complies with data frame format which is referred to herein as the “legacy IEEE 802.11 BSS data frame format.” To successfully propagate the first unified groupcast data frame format in the network, all of the information needed for the “IEEE 802.11s WDS mesh data frame format” is included in the limited fields which make up the legacy IEEE 802.11 BSS data frame format. This helps ensure operational compatibility with non-meshed legacy 802.11 stations.

In another embodiment, when QoS support is desired, a second unified groupcast data frame format may comprise all of the information required by the IEEE 802.11e QoS BSS (QBSS) data frame format, and the IEEE 802.11s WDS data frame format. The information required by the IEEE 802.11s WDS mesh groupcast data frame format is provided within the normal IEEE 802.11e QoS BSS (QBSS) data frame format. The second unified groupcast data frame format allows QoS stations (QSTAs) in the QBSS and MAPs and MPs in the WDS with QoS capability to receive a single packet and interpret it. The second unified groupcast data frame format is useful, for example, in the context of groupcast communications which occur in an IEEE 802.11 s compliant network in which all stations have QoS capability.

In one embodiment, a method is provided for generating a groupcast packet or packets. According to this method, in a network comprising a meshed access point and at least one node attached to the meshed access point, the meshed access point can determine whether the nodes attached to the meshed access point include at least one QoS station (QSTA) and/or at least one legacy station (LSTA).

If the nodes attached to the meshed access point include at least one LSTA or legacy stations (LSTAs) (and/or QSTAs and/or QAPs), the meshed access point can generate a groupcast packet having a first data frame format (e.g., a modified IEEE 802.11 legacy BSS data frame format), and transmit it to the attached nodes including the at least one LSTA. The first data frame format comprises: a header and groupcast information. The header comprises a sequence control field comprising a mesh end-to-end sequence number. As such, information that is normally in an IEEE 802.11s WDS mesh groupcast data frame format can be fit within an IEEE 802.11 legacy BSS data frame format.

By contrast, if the attached nodes do not include LSTAs (e.g., when all stations receiving groupcast data are QSTAs, QAPs, MAPs or other meshed devices), then the meshed access point can generate a different groupcast packet having a second data frame format (e.g., a modified IEEE 802.11e QoS BSS (QBSS) data frame format) and transmit the different groupcast packet to the attached nodes. The second data frame format comprises: a header and groupcast information, wherein the header comprises: a sequence control field comprises a mesh end-to-end sequence number, and a QoS control field comprising a time-to-live (TTL) value. As such, all of the IEEE 802.11s WDS mesh groupcast data frame format information can be fit into an IEEE 802.11e QBSS data frame format.

In either case, the need to send duplicate packets is eliminated.

Exemplary Unified Groupcast Data Frame Formats

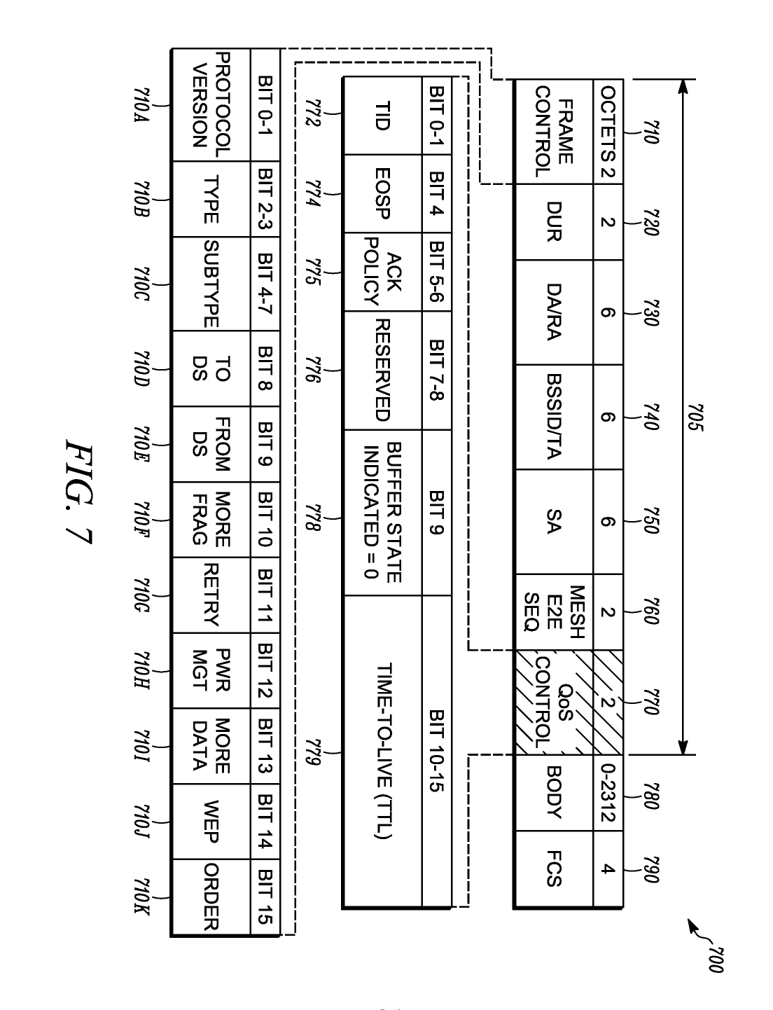

FIG. 7 is a data structure which illustrates a unified groupcast data frame formats 700 in accordance with some embodiments of the present invention. When an application data frame is to be groupcast, it should be sent as a single copy to the network (including both BSS and WDS) from the source MAP using the unified groupcast data frame format 700. Depending on the particular implementation (i.e., whether or not QoS functionality is being implemented), the unified groupcast data frame format 700 can be referred to as either a modified IEEE 802.11 legacy BSS data frame format or a modified IEEE 802.11e QoS BSS (QBSS) data frame format. To explain further, when the QoS control field 770 is not included, the unified groupcast data frame format can be referred to as “a modified legacy IEEE 802.11 BSS data frame format.” When the QoS control field 770 is included, the unified groupcast data frame format can be referred to as “a modified conventional IEEE 802.11e QoS Basic Service Set (BSS) data frame format.”

The unified groupcast data frame format 700 comprises a MAC data header 705, a packet body field 780 and a frame check sum field (FCS) 790. The MAC header 705 comprises a frame control field 710, a duration field 720, address fields 730-750, a sequence control field 760, and an optional QoS control field 770. The body field 780 comprises data or “payload” information. The body field 780 moves the higher-layer payload from station to station. The FCS field 790 contains a cyclic redundancy check (CRC) which allows stations to check the integrity of the received frames and to detect errors in the frame which may have occurred during transmission. The FCS field 790 is calculated over the MAC header 705 and the packet body field 780.

The frame control field 710 comprises a protocol version sub-field 710A, a type sub-field 710B, a subtype sub-field 710C, a ToDS bit 710D, a FromDS bit 710E, a more fragment bit 710F, a retry bit 710G, a power management bit 710H, a more data bit 710I, a WEP bit 710J and an order bit 710K. When the application data frame is a groupcast packet and the source MAP utilizes the unified groupcast data frame format 700, the source MAP should set the FromDS bit as 1, ToDS bit as 0.

The duration field 720 contains a duration time value that is proportional to the length of the frame in bits.

The address fields 730-750 comprise a destination/receiver (DA/RA) address field 730 that identifies the final recipient of the data frame (e.g., the station that will hand the frame to the higher protocol layers for processing), a BSSID/transmitter address (BSSID/TA) field 740 that identifies the MAC address used by the wireless interface in the MAP, and a source address (SA) field 750 that identifies the source of the transmission. The address fields 730-750 each comprise a 48-bit IEEE MAC identifier. If the first bit sent to the physical medium is a 0, the address represents a single station (unicast). When the first bit is a 1, the address represents a group of physical stations and is called a multicast (or group) address. If all bits are 1s, then the frame is a broadcast and is delivered to all stations connected to the wireless medium. When the application data frame is a groupcast packet and the source MAP utilizes the unified groupcast data frame format 700, the MAP sets the destination/receiver (DA/RA) address field 730 to the destination groupcast address (including broadcast and multicast address), sets the BSSID/transmitter address (BSSID/TA) field 740 to the transmitting MAP's address, and sets the source address (SA) field 750 to the original source node address (e.g., the real data originator address) which can be an 802.11 station or an 802.11 AP. The source MAP can be the real data originator or the MAP that the real data originator (an 802.11 legacy station) is associated with and serving as a proxy for.

In groupcast scenarios of the 802.11 standards, the sequence control field can be ignored because there is no retransmission mechanism for the groupcast packet. In accordance with some embodiments of the present invention, a mesh end-to-end sequence number 760 is provided in the field normally provided for the sequence control field. This helps ensure proper groupcast traffic propagation throughout the network using single copy of groupcast packet. When the source address field 750 identifies a MAP (e.g., if the source MAP is the real data originator or the real data originator is attached to the source MAP through a wired connection (such as IEEE 802.3)), the mesh end-to-end sequence number field 760 is the groupcast end-to-end sequence number maintained by the MAP/IAP. When the source address field 750 identifies a legacy station, the mesh end-to-end sequence number field 760 is described in above-referenced U.S. patent application Ser. No. 11/383,130.

When a LSTA receives the groupcast packet, pursuant the IEEE 802.11 standards, the LSTA ignores the mesh end-to-end sequence number 760 field. Each MAP records the mesh end-to-end sequence number for every source node identified in the source address (SA) field for each groupcast packet received in a past time window to indicate that the groupcast packet with this specific mesh end-to-end sequence number from this specific SA has been received. This record should be kept for a period. As such, several mesh end-to-end sequence numbers may be recorded in the mesh node for all the groupcast packet received from that source address during that duration. The structure can be several <SA, mesh end-to-end sequence number> for the same SA and different sequence number, or it can be <SA, mesh end-to-end sequence number list> where several mesh sequence numbers are recorded in the list. When the MAP receives the same groupcast packet, the MAP can map the mesh end-to-end sequence number 760 field and the source address (SA) field 750 to produce a tuple <SA, mesh end-to-end sequence number > to determine whether or not the groupcast packet is a duplicate according the recorded <SA, mesh end-to-end sequence number list> tuple, and then decide whether or not to accept this groupcast packet based on that determination. This is done by comparing the “mesh end-to-end sequence number” of the received frame to the past mesh end-to-end sequence number recorded in the “mesh end-to-end sequence number list” maintained by the MAP for the same source node. If the current “mesh end-to-end sequence number” does not match any mesh end-to-end sequence number in this list, then the frame is new and is not a duplicate packet, and the MAP will accept the groupcast packet and further process it. If groupcast forwarding conditions are satisfied, the MAP will rebroadcast it into the network in an appropriate version of the unified groupcast data frame format 700. In some implementations, the groupcast forwarding conditions can be based on: the TTL in the QoS Control field (described below), information maintained in a multicast route table, etc.

The QoS control field 770 is optional and is not used in some embodiments. As such, the QoS Control field 770 and sub-fields 772-779 are shown in shading to indicate that the QoS Control field 770 is used only in one of the two versions of the unified groupcast data frame formats. When the QoS control field 770 is not included, this version of the unified groupcast data frame format can be referred to as “a modified legacy IEEE 802.11 BSS data frame format” since it is similar to the legacy IEEE 802.11 BSS data frame format. When the QoS control field 770 is included, this version of the unified groupcast data frame format can be referred to as “a modified conventional IEEE 802.11e QoS Basic Service Set (BSS) data frame format” since it is similar to the conventional IEEE 802.11e QoS Basic Service Set (BSS) data frame format. As shown in FIG. 7, the QoS control field 770 comprises a number of sub-fields 772-779 (as shown in the bottom portion of FIG. 7) including a Traffic Identification (TID) sub-field 772, an End Of Service Period (ESOP) sub-field 774, an acknowledgement (ACK) policy sub-field 775 that specifies a type of acknowledgement policy being used (these are defined in the IEEE 802.11e standards), reserved sub-field 776, a buffer state indicated sub-field 778, and sub-field 779. As described above with reference to FIG. 4, the sub-field 479 would normally be a reserved sub-field.

In the context of a unicast packet, the buffer state indicated sub-field 778 is set equal to one so that the bits 10-15 can be interpreted as a highest-priority buffered AC (bits 10-11) and a QAP buffered load (bits 12-15). By contrast, when the packet is a groupcast packet (e.g., packet is intended for multiple different receivers) it is unnecessary to indicate a buffer state since the packet is intended for a group of stations and is not being unicast to an individual receiver. In this embodiment, the buffer state indicated sub-field 778 can be set equal to zero.

In some embodiments of the present invention in which the QoS control field 770 is implemented, the unified groupcast data frame format 700 utilizes sub-field 779 of the QoS control field 770 to carry a time-to-live (TTL) value 779 that is set to control the groupcast traffic propagation range by specifying the number of hops the packet is allowed to pass before it dies. For example, in one implementation, when the buffer state indicated sub-field 778 is set equal to zero, bits 10-15 can be reserved for the time-to-live (TTL) value 779. This way, if the tuple <SA, mesh end-to-end sequence number > can not be used to determine if the groupcast packet is a duplicate, then the node can use the time-to-live (TTL) value 779 to determine when the packet should stop being retransmitted so that it does not continue propagating in the network.

In addition, in some implementations, a bit in the reserved sub-field 776 can be used to indicate whether this is the single copy for both BSS stations and WDS stations, or this is the copy only intended for BSS stations. This variation can create the flexibility for some group traffic only intended for BSS stations (such as some IGMP traffic only destined to the BSS stations), and can avoid the flooding effect for this kind of traffic.

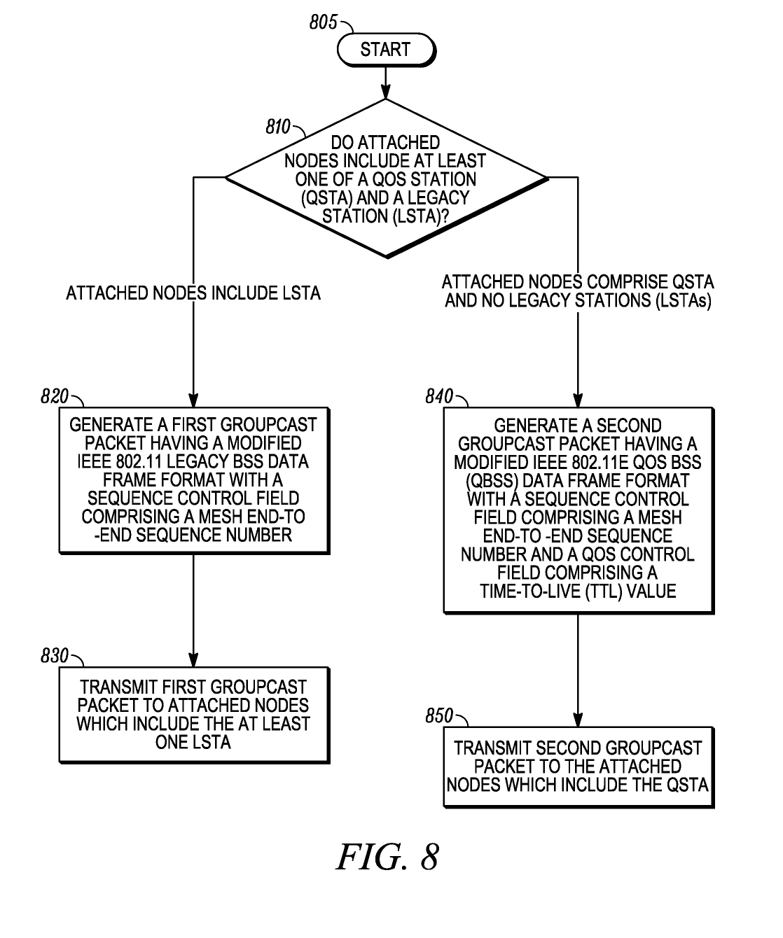

FIG. 8 is a flowchart illustrating an exemplary method 800 for determining a format of a groupcast packet in accordance with some embodiments of the present invention. The method 800 can be used, for example, by a meshed access point (MAP) to determine how to format a groupcast packet before transmitting (e.g., broadcast or multicasting) to other node(s) attached to the MAP.

At step 810, the meshed access point can determine whether the nodes attached to the meshed access point include at least one of a QoS station (QSTA) and a legacy station (LSTA).

If the attached nodes include at least one LSTA, then at step 820 the MAP can generate a groupcast packet having a modified IEEE 802.11 legacy BSS data frame format which comprises a header and groupcast information. The header comprises a mesh end-to-end sequence number inserted into the field that is normally reserved for the sequence control field. In this scenario, the QoS control field 770 is not included in the groupcast packet. At step 830, the MAP may then transmit the groupcast packet to the attached nodes which include the at least one LSTA, and possibly other types of nodes or stations depending on the network configuration.

If the attached nodes comprise no legacy stations (LSTAs) and at least one QSTA, then at step 840 the MAP can generate a different groupcast packet having a modified IEEE 802.11e QoS BSS (QBSS) data frame format which comprises a header and groupcast information. The header comprises: a mesh end-to-end sequence number inserted into the field that is normally reserved for the sequence control field, and a time-to-live (TTL) value inserted into the QoS control field. At step 850, the MAP may then transmit the different groupcast packet to the attached nodes which include the at least one QSTA, and possibly other types of nodes or stations depending on the network configuration.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A data frame format generated by a meshed access point when attached nodes include at least one legacy station (LSTA), wherein the data frame format comprises:
a header comprising a sequence control field comprising a mesh end-to-end sequence number; and
one or more groupcast information.

2. A data frame format according to claim 1, wherein the data frame format comprises:
a modified IEEE 802.11 legacy BSS data frame format.

3. A data frame format generated by a meshed access point when attached nodes comprise at least one Quality-of-Service station (QSTA) and no legacy stations (LSTAs), wherein the data frame format comprises:
a header comprising: a sequence control field, and a QoS control field comprising a time-to-live (TTL) value, wherein the sequence control field comprises a mesh end-to-end sequence number; and
one or more groupcast information.

4. A data frame format according to claim 3, wherein the data frame format comprises:
a modified IEEE 802.11e QoS BSS (QBSS) data frame format.

5. In a network comprising a meshed access point and at least one node attached to the meshed access point, a method comprising:
determining, at the meshed access point, whether the nodes attached to the meshed access point include at least one of a QoS station (QSTA) and a legacy station (LSTA);
generating, at the meshed access point, a groupcast packet having a data frame format when the attached nodes include at least one LSTA, wherein the data frame format comprises:
a header comprising a sequence control field comprising a mesh end-to-end sequence number; and
one or more groupcast information.

6. A method according to claim 5, further comprising:
transmitting the groupcast packet to the attached nodes.

7. A method according to claim 6, wherein the data frame format comprises: a modified IEEE 802.11 legacy BSS data frame format.

8. A method according to claim 7, wherein the attached nodes comprise at least one of a meshed point and a meshed access point, and further comprising:
receiving, at the at least one of the meshed point and the meshed access point, the groupcast packet; and
processing the received groupcast packet at the at least one of the meshed point and the meshed access point.

9. A method according to claim 8, wherein the step of processing the received groupcast packet further comprises:
examining a “ToDS” bit in the received groupcast packet at the at least one of the meshed point and the meshed access point;
determining that the “ToDS” bit is set to zero (0); and
accepting the received groupcast packet for further processing, at the at least one of the meshed point and the meshed access point, even though the “ToDS” bit is set to zero (0).

10. A method according to claim 8 wherein the step of processing the received groupcast packet further comprises:
determining if the received groupcast packet is a duplicate packet; and
discarding the received groupcast packet if the received groupcast packet is a duplicate; or
accepting the received groupcast packet for further processing if the received groupcast packet is not a duplicate, and then retransmitting the received groupcast packet.

11. A method according to claim 10, wherein the header further comprises a source address (SA) field, and wherein the step of determining if the received groupcast packet is a duplicate packet further comprises:
recording for each groupcast packet received by the at the at least one of the meshed point and the meshed access point, a recorded <SA, mesh end-to-end sequence number> tuple to establish that a particular groupcast packet having a specific mesh end-to-end sequence number has been received from a specific source address, wherein each of the recorded <SA, mesh end-to-end sequence number> tuples comprise: a specific mesh end-to-end sequence number for a specific source node identified in a specific source address (SA) field for each groupcast packet; and,
wherein the step of determining if the received groupcast packet is a duplicate packet further comprises:
mapping, at the at least one of the meshed point and the meshed access point, the mesh end-to-end sequence number field of the received groupcast packet and the source address (SA) field of the received groupcast packet to produce a received tuple <SA, mesh end-to-end sequence number >; and
determining whether the received groupcast packet is a duplicate by comparing the received tuple <SA, mesh end-to-end sequence number> to the recorded <SA, mesh end-to-end sequence number> tuples to determine whether the mesh end-to-end sequence number of the received groupcast packet matches any of the specific mesh end-to-end sequence numbers recorded for the same source address.

12. A method according to claim 11, further comprising:
discarding the received groupcast packet as a duplicate if the mesh end-to-end sequence number of the received groupcast packet matches any of the specific mesh end-to-end sequence numbers recorded for the same source address;
determining that the received groupcast packet is not a duplicate if the mesh end-to-end sequence number of the received groupcast packet does not match any of the specific mesh end-to-end sequence numbers recorded for the same source address; and accepting the packet for further processing.

13. A method according to claim 5, further comprising:
generating, at the meshed access point, a different groupcast packet having a different data frame format if the attached nodes comprise no legacy stations (LSTAs) and at least one QSTA, wherein the different data frame format comprises:
a header comprising: a sequence control field, and a QoS control field comprising a time-to-live (TTL) value, wherein the sequence control field comprises a mesh end-to-end sequence number; and
groupcast information.

14. A method according to claim 13, further comprising:
transmitting the different groupcast packet to the attached nodes.

15. A method according to claim 14, wherein the different data frame format comprises: a modified IEEE 802.11e QoS BSS (QBSS) data frame format.

16. In a network comprising a meshed access point and at least one node attached to the meshed access point, a method comprising:
determining, at a meshed access point, whether the nodes attached to the meshed access point include at least one of a QoS station (QSTA) and a legacy station (LSTA); and
generating, at the meshed access point, a groupcast packet having a data frame format when the attached nodes comprise no legacy stations (LSTAs) and at least one QSTA, wherein the data frame format comprises:
a header comprising: a sequence control field, and a QoS control field comprising a time-to-live (TTL) value, wherein the sequence control field comprises a mesh end-to-end sequence number; and
one or more groupcast information.

17. A method according to claim 16, further comprising:
transmitting the groupcast packet to the attached nodes.

18. A method according to claim 17, wherein the data frame format comprises: a modified IEEE 802.11e QoS BSS (QBSS) data frame format.

19. A method according to claim 18, wherein the attached nodes comprise at least one of a meshed point and a meshed access point, and further comprising:
receiving, at the at least one of the meshed point and the meshed access point, the groupcast packet; and
processing the received groupcast packet at the at least one of the meshed point and the meshed access point.

20. A method according to claim 19, wherein the step of processing the received groupcast packet further comprises:
examining a “ToDS” bit in the received groupcast packet at the at least one of the meshed point and the meshed access point;
determining that the “ToDS” bit is set to zero (0); and
accepting the received groupcast packet for further processing, at the at least one of the meshed point and the meshed access point, even though the “ToDS” bit is set to zero (0).

21. A method according to claim 20, wherein the QoS control field further comprises a reserved sub-field, and wherein a bit in the reserved sub-field is set to indicate whether the groupcast packet is intended for:
one or more BSS stations, or
both one or more BSS stations and one or more WDS stations.

22. A method according to claim 19, wherein the step of processing the received groupcast packet further comprises:
determining if the received groupcast packet is a duplicate packet; and
discarding the received groupcast packet when the received groupcast packet is a duplicate; or
accepting the received groupcast packet for further processing when the received groupcast packet is not a duplicate, and then retransmitting the received groupcast packet.

23. A method according to claim 22, wherein the header further comprises a source address (SA) field, and wherein the step of determining if the received groupcast packet is a duplicate packet further comprises:
recording for each groupcast packet received by the at the at least one of the meshed point and the meshed access point, a recorded <SA, mesh end-to-end sequence number> tuple to establish that a particular groupcast packet having a specific mesh end-to-end sequence number has been received from a specific source address, wherein each of the recorded <SA, mesh end-to-end sequence number> tuples comprise: a specific mesh end-to-end sequence number for a specific source node identified in a specific source address (SA) field for each groupcast packet; and,
wherein the step of determining if the received groupcast packet is a duplicate packet further comprises:
mapping, at the at least one of the meshed point and the meshed access point, the mesh end-to-end sequence number field of the received groupcast packet and the source address (SA) field of the received groupcast packet to produce a received tuple <SA, mesh end-to-end sequence number >; and
determining whether the received groupcast packet is a duplicate by comparing the received tuple <SA, mesh end-to-end sequence number > to the recorded <SA, mesh end-to-end sequence number> tuples to determine whether the mesh end-to-end sequence number of the received groupcast packet matches any of the specific mesh end-to-end sequence numbers recorded for the same source address.

24. A method according to claim 23, further comprising:
discarding the received groupcast packet as a duplicate when the mesh end-to-end sequence number of the received groupcast packet matches any of the specific mesh end-to-end sequence numbers recorded for the same source address; and
determining that the received groupcast packet is not a duplicate when the mesh end-to-end sequence number of the received groupcast packet does not match any of the specific mesh end-to-end sequence numbers recorded for the same source address; and accepting the packet for further processing.

25. A method according to claim 24, further comprising:
determining if the time-to-live (TTL) value specified in the header of the received groupcast packet has expired; and
when the time-to-live (TTL) value specified in the header of the received groupcast packet has not expired, retransmitting the received groupcast packet from the at least one of the meshed point and the meshed access point.

26. A method according to claim 16, further comprising:
generating, at the meshed access point, a different groupcast packet having a different data frame format when the attached nodes include at least one LSTA, wherein the different data frame format comprises: a header comprising: a sequence control field comprising a mesh end-to-end sequence number; and groupcast information; and
transmitting the different groupcast packet to the attached nodes.

27. A method according to claim 26, wherein the different data frame format comprises: a modified IEEE 802.11 legacy BSS data frame format.
